(19) United States
(12) Patent Application Publication
(10) Pub. No.: US 2007/0240941 A1
(43) Pub. Date: Oct. 18, 2007

(54) Brake shoe for use in elevator safety gear

(76) Inventor: Daniel Fischer, Villarsel-sur-Marly (CH)

Correspondence Address: Thomas Moga;Butzel Long, STONERIDGE WEST, 41000 WOODWARD AVENUE, BLOOMFIELD HILLS, MI, 48304, US

(21) Appl. No.: 11/374,301

(22) Filed: Dec. 23, 2005

(30) Foreign Application Priority Data
Dec. 21, 2005 (EP) 05112667.0

(51) Int. Cl. B66B 5/16; F16D 69/00

(52) U.S. Cl. 187/359; 188/251 A

(57) ABSTRACT

The present invention relates to a brake shoe (5) for use in an elevator safety gear (4). In use, the safety gear (4) exerts a specific application force (N) to the brake shoe (5) causing the brake shoe (5) to frictionally engage with a guide rail (3). A frictional braking force (F₁,F₂) developed by the brake shoe (5) increases during engagement.

The present invention relates to brake shoes and, in particular, to brake shoes for use in elevator safety gear.

In a conventional elevator system, an elevator car travels up and down within an elevator hoistway along guide rails. At least one safety gear is mounted on the car to arrest motion of the car if an overspeed governor detects that the car is travelling at an excessive speed. In such situations the governor triggers the safety gear to apply a brake shoe to the guide rail to generate a frictional braking force thereby bringing the car to an eventual halt. There are a number of possible causes giving rise to an overspeed situation ranging from a first category whereby a simple fault in the drive such as a malfunctioning controller for example results in the car travelling above the predetermined overspeed value to a second, more serious but fortunately less frequent, category sometimes referred to as free-fall whereby the car is disconnected from the drive (for example due to cable breakage in a traction elevator or jack failure in a hydraulic elevator) and accelerates down the elevator hoistway under gravitational force.

In the first category, the elevator car is supported by the drive and, if interconnected to a counterweight, at least partially balanced by that counterweight. Hence the effective mass which the safety gear must bring to halt is relatively low. On the contrary, in the second category the safety gear is required to arrest the motion of the free-falling car together with any load. Accordingly, the frictional braking force generated by the safety gear against the guide rail must be greater for the second, free-fall overspeed category than for the first overspeed category.

To prevent injury to passengers, it is generally accepted that the deceleration of the elevator car during safety gear deployment should be maintained below a specific threshold value (a figure of 1 g is often quoted). If the safety gear is set to provide the desired deceleration during the first overspeed category, then it may not be capable of effectively halting the car in a free-fall situation. On the other hand, if the safety gear is set to provide the desired deceleration during free-fall, deployment during a first category overspeed situation will undoubtedly produce a deceleration which exceeds the accepted threshold.

Accordingly, the objective of the present invention is to provide a safety gear which can be successfully deployed in all overspeed situations to arrest an elevator car without injuring passengers travelling in the elevator car.

This objective is achieved by providing a brake shoe for use in an elevator safety gear whereby, in use, the safety gear exerts a specific application force to the brake shoe causing the brake shoe to frictionally engage with a guide rail wherein a frictional force developed by the brake shoe increases during engagement. Hence, during deployment, the brake shoe will exert an initial frictional braking force against the guide rail. This initial frictional braking force is designed to halt an elevator car during a first category overspeed situation. If, however, a second category overspeed situation exists, the frictional braking force is subsequently increased to a level sufficient to arrest the free-falling elevator car.

For the majority of elevator installations, it is foreseen that the use of a safety gear which applies only a single constant force application force (for example, by means of springs) will be sufficient to arrest the elevator car without injuring the passengers. Accordingly, the associated equipment for controlling and regulating the safety gear is relatively straightforward and thereby both the initial cost and ongoing maintenance costs of the safety gear are relatively low.

Preferably, the brake shoe has a variable coefficient of friction. Accordingly, during engagement with the guide rail, the coefficient of friction between the brake shoe and the guide rail increases.

The brake shoe can comprise an outer layer and an inner layer, whereby a coefficient of friction of the inner layer is greater than a coefficient of friction of the outer layer. Hence, in use, the outer layer is initially brought into engagement with the guide rail. If the frictional braking force developed by the outer layer is incapable of arresting the car, then it is worn away to expose the inner layer. As the inner layer subsequently engages with the guide rail the frictional braking force developed is increased due to the increase in the coefficient of friction to a level sufficient to arrest the free-falling elevator car.

Alternatively, the coefficient of friction of the brake shoe can be proportional to temperature. Hence, during frictional braking, the temperature of the brake shoe will gradually increase resulting in a corresponding increase in the coefficient of friction.

Preferably, a cross-sectional area that the brake shoe presents to the guide rail increases during engagement. This arrangement is particularly beneficial in the two layer brake shoe defined above by ensuring a regressive wear rate of the brake shoe whereby the first layer is worn through relatively quickly compared to the second layer.

The present invention is hereinafter described by way of specific examples with reference to the accompanying drawings in which:

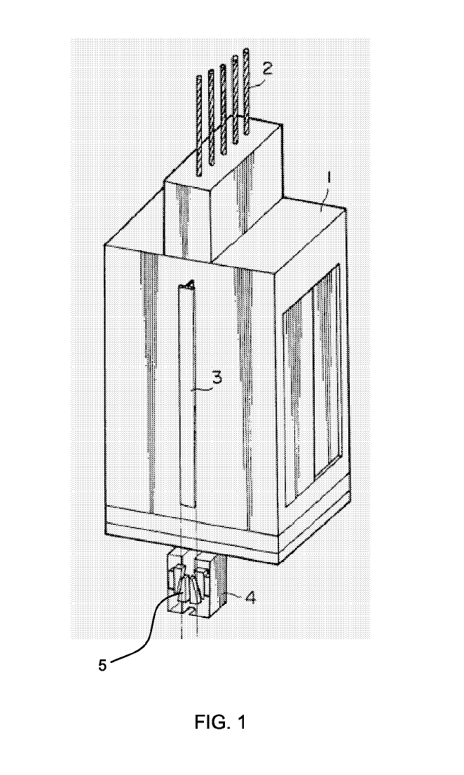

FIG. 1 is a perspective view of an elevator car incorporating a conventional safety gear with brake shoes according to the present invention;

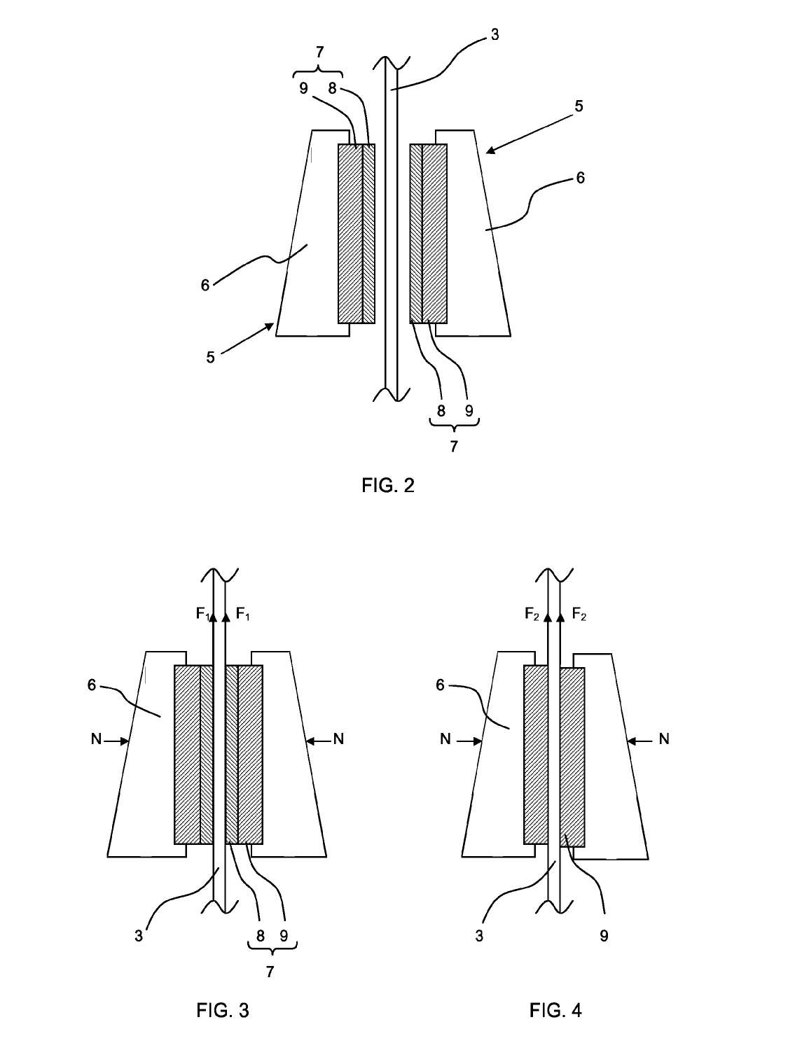

FIG. 2 is a sectional view of a set of brake shoes in accordance with a first embodiment of the present invention;

FIG. 3 illustrates an initial engagement of the brake shoes of FIG. 2 against a guide rail immediately after an overspeed condition has been detected;

FIG. 4 illustrates a subsequent engagement of the brake shoes of FIGS. 2 and 3 against a guide rail;

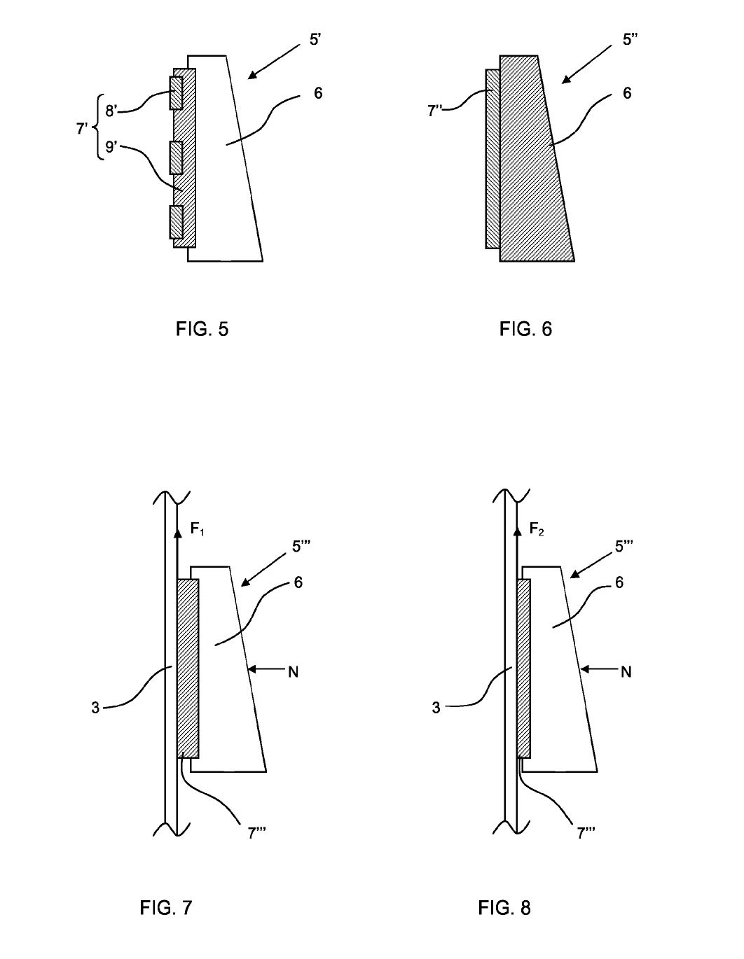

FIG. 5 is a sectional view of a brake shoe according to a second embodiment of the present invention;

FIG. 6 is a sectional view of a brake shoe according to a third embodiment of the present invention;

FIG. 7 illustrates an initial engagement of a brake shoe according to a fourth embodiment against a guide rail immediately after an overspeed condition has been detected; and

FIG. 8 illustrates a subsequent engagement of the brake shoe of FIG. 7 against a guide rail.

FIG. 1 is a perspective view of an elevator car 1 incorporating a conventional safety gear 4 with brake shoes 5 according to the present invention. In a conventional traction elevator, the car 1 is connected by cables 2 to a counterweight (not shown). This interconnected arrangement of car 1 and counterweight is driven by a traction machine and associated traction sheave (not shown) such that the car travels along guide rails 3 mounted within an elevator hoistway to transport passengers to their desired destination. A safety gear 4 is mounted on the bottom of the car 1 so as to surround a neighbouring guide rail 3. Although only a single guide rail 3 and safety gear 4 is shown, it will be appreciated that an identical arrangement is provided on the opposite side of the car 1.

In an overspeed situation when the car 1 travels at a speed in excess of a predetermined value, an overspeed governor (not shown) triggers the safety gear 4 to apply brake shoes 5 to opposing side of the guide rail 3 to generate a frictional braking force and thereby bring the car 1 to an eventual halt.

FIG. 2 is a sectional view of a set of brake shoes 5 in accordance with a first embodiment of the present invention. Each brake shoe 5 comprises a brake shoe body 6 which retains a brake pad 7. The brake pad 7 has an outer sacrificial layer 8 which faces towards the guide rail 3 and an inner layer 9 disposed between the outer layer 8 and the brake shoe body 6. The coefficient of friction μ₁ of the material forming the outer layer 8 is less than the coefficient of friction μ₂ of the material forming the inner layer 9.

FIGS. 3 and 4 illustrate the deployment of the brake shoes 5 after an overspeed situation has been detected by the governor. A clamping force N is applied to each brake shoe 5 by the safety gear 4 causing the brake pads 7 to frictionally engage with the guide rail 3. In an initial phase of deployment, as shown in FIG. 3, the outer sacrificial layer 8 of each brake pad 7 generates a frictional braking force F₁ against the guide rail 3. This initial frictional braking force F₁ is intended to arrest the elevator car 1 which, although interconnected to, and thereby supported by, the traction machine and the counterweight, is travelling above the predetermined overspeed value possibly due to a fault in the drive such as a malfunctioning controller.

If, on the other hand, the car overspeed is due to a complete breakage of the cables 2, for example, the frictional braking force F₁ developed by the brake pad 7 during the initial deployment phase may not be sufficient to effectively arrest the car 1. In such a situation, the outer sacrificial layer 8 of the brake pad 7 is worn or melted away through excessive frictional engagement with the guide rail 3 to expose the inner layer 9. Since the coefficient of friction μ₂ of the inner layer 9 is greater than the coefficient of friction μ₁ of the inner layer 8, the frictional braking force the brake pad 7 develops against the guide rail 3 increases to a level F₂ as the inner layer 9 subsequently engages with the guide rail 7 in a second deployment phase, as shown in FIG. 4. The frictional braking force F₂ during this second deployment phase is sufficient to arrest the free-falling elevator car 1.

FIG. 5 is a sectional view of a brake shoe 5′ according to a second embodiment of the present invention. As in the previous embodiment, the brake shoe 5′ incorporates a brake shoe body 6 to retain a brake pad 7′. In this instance, the brake pad 7′ consists of blocks 8′ embedded into and projecting from a brake pad layer 9′. The coefficient of friction μ₁ of the material forming the blocks 8′ is less than the coefficient of friction μ₂ of the material forming the brake pad layer 9′. The brake pad 7′ is activated in exactly the same manner as in the previously described embodiment with the blocks 8′ of the brake pad 7′ providing the frictional braking force F₁ during the first deployment phase. If the blocks 8′ are worn away, the brake pad layer 9′ comes into engagement with the guide rail 3 to generate a greater frictional braking force F₂ during the second deployment phase. In the present embodiment, the surface area of the brake pad 7′ presented to the guide rail 3 during application increases. This ensures a regressive wear rate of the brake pad 7′ whereby the blocks 8′ are worn through relatively quickly compared to the brake pad layer 9′.

FIG. 6 is a sectional view of a brake shoe 5″ according to a third embodiment of the present invention. Again the brake pad 7″ is supported on a brake shoe body 6 however, in this instance, the brake pad 7″ is formed from a single material having a relatively low coefficient of friction μ₁ to generate the frictional braking force F₁ during the first deployment phase. The brake shoe body 6 itself is formed from a material having a relatively high coefficient of friction μ₁ and is used during the second deployment phase to generate a greater frictional braking force F₂ during the second deployment phase.

FIGS. 7 and 8 illustrate the engagement of a brake shoe 5′″ according to a fourth embodiment against a guide rail 3. The brake shoe 5′″ comprises a brake shoe body 6 which retains a brake pad 7′″. In this embodiment, the brake pad 7′″ is manufactured from a single material having a coefficient of friction μ which is proportional to its temperature. When an overspeed situation has been detected by the governor, a clamping force N is applied to the brake shoe 5′″ by the safety gear 4. As shown specifically in FIG. 7, when the brake pad 7′″ initially engages with the guide rail 3 it is at ambient temperature and accordingly has a relatively low coefficient of friction μ₁. Hence, the initial frictional braking force F₁ generated by the brake pad 7′″ against the guide rail 3 is relatively low.

During continued braking as illustrated in FIG. 8, heat is generated in the brake pad 7′″ causing its coefficient of friction to progressively increase. This, in turn, results in a progressive increase in the frictional braking force to a level F₂ which is sufficient to arrest a free-falling car 1.

It will be readily appreciated that specific features of the described embodiments can be interchanged to give further embodiments according to the present invention.

Furthermore, although the inter-surfaces between the brake pad components and indeed between the brake pad and the brake shoe body are shown as being planar and generally parallel to the guide rail, it will be understood that other surface profiles (grooved, V-shaped etc.) can be used to reduce the effects of shear force acting between the discrete brake shoe components.

The skilled person will acknowledge that there are a wide variety of materials available to achieve the specific characteristics required for each discrete component of the brake shoe and that selection of specific materials will be largely dependent on the characteristics of the elevator itself such as the rated speed, the rated loading, the travel height, the type of safety gear and the application force it exerts on the brake shoes. For example, if the brake shoe of the first embodiment is used in a small installation having a rated speed of 1 m/s, then the outer sacrificial layer 8 can be manufactured from a polymeric material while the inner layer 9 can be formed from a conventional brake shoe material such as mild steel.

Although the described embodiments have been described with reference to a specific safety gear, it will be appreciated that the brake shoes according to the invention can be employed in any calliper brake set which is used to frictionally engage the guide rails to decelerate the elevator car of a traction or a hydraulic elevator installation.

1-8. (canceled)

9. A brake shoe for use in an elevator safety gear comprising: the brake shoe being formed of a material whereby, in use, the safety gear exerts a specific application force to the brake shoe causing the brake shoe to frictionally engage with a guide rail wherein a frictional braking force developed by the brake shoe material increases during the engagement with the guide rail.

10. The brake shoe according to claim 9 wherein said material has a variable coefficient of friction.

11. The brake shoe according to claim 9 wherein said material has a first layer for initial engagement with the guide rail and a second layer for subsequent engagement with the guide rail, wherein a coefficient of friction of said second layer is greater than a coefficient of friction of said first layer.

12. The brake shoe according to claim 11 wherein said first layer and said second layer are incorporated in a brake pad removably retained by a brake shoe body.

13. The brake shoe according to claim 11 wherein said first layer is formed from blocks embedded into and projecting from said second layer.

14. The brake shoe according to claim 11 wherein said first layer is incorporated in a brake pad and said second layer is provided by a brake shoe body.

15. The brake shoe according to claim 9 wherein a coefficient of friction of the brake shoe is proportional to temperature.

16. The brake shoe according to claim 9 wherein a cross-sectional area presented by the brake shoe to the guide rail increases during engagement.

17. A brake shoe for use in an elevator safety gear comprising: the brake shoe being formed of a material whereby, in use, the safety gear exerts a specific application force to the brake shoe causing the brake shoe to frictionally engage with a guide rail wherein a frictional braking force developed by the brake shoe material increases during the engagement with the guide rail, said material having a variable coefficient of friction, and wherein a cross-sectional area presented by the brake shoe to the guide rail increases during engagement.
